(19) United States
(12) Patent Application Publication
(10) Pub. No.: US 2020/0216346 A1
(43) Pub. Date: Jul. 9, 2020

(54) WASTEWATER TREATMENT PROCESS FOR REMOVING CHEMICAL OXYGEN DEMAND

(71) Applicant: SOLVAY SA, Brussels (BE)

(72) Inventors: Feng WANG, Shanghai (CN); Stéphanie FOUCHER, Shanghai (CN); Zhouying JI, Shanghai (CN); Fan LIU, Shanghai (CN)

(21) Appl. No.: 16/625,049

(22) PCT Filed: Jun. 29, 2017
(86) PCT No.: PCT/CN2017/090732

§ 371 Date: Dec. 20, 2019

(51) Int. Cl. C02F 9/00

(52) U.S. Cl. CPC C02F 9/00; C02F 1/66

(57) ABSTRACT

A process for removing chemical oxygen demand, which realizes the deep COD treatment by the combination of metal salt and hydrogen peroxide and then by an ozone containing gas with hydrogen peroxide or ultraviolet radiation with hydrogen peroxide. It features using less metal salt and hydrogen peroxide, having less ozone gas residual and being more suitable for industrialization.

### TECHNICAL FIELD

The present invention concerns a process for removing chemical oxygen demand, which realizes the deep COD treatment by the combination of metal salt and hydrogen peroxide and then by an ozone containing gas with hydrogen peroxide or ultraviolet radiation with hydrogen peroxide.

### PRIOR ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

It has been long known that Fenton's reagent is a solution of hydrogen peroxide with ferrous iron as a catalyst that is used to oxidize contaminants or wastewaters. Although there are lots of wastewater treatment methods involving Fenton's reagent, they are specifically designed for destroying or removing specific compounds or for even specific amount of compounds in the wastewater.

In most of the Fenton reactions, excess hydrogen peroxide is present in the reaction medium considering introduced transition-metal salt, such as ferrous sulfate. For example, CN104016525A discloses a metal mine mineral separation wastewater treatment method which involves an ultraviolet-Fenton oxidation reaction by using of a Fenton reagent and a catalyst. According to the examples in this patent application, the moles of hydrogen peroxide were much higher than ferrous sulfate. In additional a coagulation reagent was introduced to perform coagulation in this invention. CN106242018A discloses a method for improving wastewater COD degradation efficiency and biochemical properties. The method concerns a combined process of Fenton oxidation, ozone oxidation and electro-catalytic oxidation. Specifically, the COD in waste water is comprised from 80000 to 300000 mg/L. The molar ratio of ferrous sulfate to hydrogen peroxide is comprised from 1:6 to 1:12.

JP62273098A2 teaches a method in which raw water is oxidized by a Fenton's reagent and the oxidized water is subjected to ozone treatment in an acidic region. In an ozone treatment process, the reaction liquid obtained in the Fenton oxidizing process is introduced into an ozone oxidizing tower from the top part thereof as it is without being neutralized. However, due to poor ozone utilization efficiency in an acidic region, the residual amount of ozone gas in the water is still high.

CN103964607B relates to a method for treating organic waste water, in particular to a clay mineral enhanced catalytic system sulfite treatment of organic wastewater. The clay mineral can act as the catalyst carriers and adsorbents. The metals contained in the clay can also act as catalyst. Nevertheless, the metal amount in the clay is not so stable that the catalytic efficiency is difficult to be ensured.

CN101723485B reports a reverse osmosis concentrated water treatment method comprising: a reverse osmosis concentrated water to be treated is added with an oxidant for oxidation reaction. After reaction, wastewater can be discharged directly. Said oxidant could be ozone, chlorine dioxide or chlorine, preferably ozone.

According to CN101723485B, said oxidant may also be hydrogen peroxide, chlorine dioxide, chlorine, ozone or sodium hypochlorite, preferably hydrogen peroxide. A catalyst should be employed and oxidation reaction is followed by a flocculation step when those oxidants are used. Said catalyst may be a transition metal ion chosen from Fe²⁺, Mn²⁺, Ni²⁺, Co²⁺, Cd²⁺, Cu²⁺, Ag⁺, Cr³⁺ and Zn²⁺ or any combination, or metal oxide chosen from MnO₂, the TiO₂, Al₂O₃ or any combination. However, large amount of catalyst (0.1-50 mol/L) needs to be used in this invention, which increases the difficulty in removing sludge to be produced.

As such, there remains a need to develop a novel process for treating wastewater comprising at least chemical oxygen demand (COD) comprised from 100 to 500 mg/L which features using less metal salt and hydrogen peroxide, having less ozone gas residual, being more suitable for industrialization. The treated water can well meet the industrial emission standard.

### Invention

It is therefore an objective of this invention to provide a process for treating wastewater comprising at least chemical oxygen demand (COD) comprised from 100 to 500 mg/L, comprising at least the following steps:

(a) contacting at least the wastewater with a composition comprising at least one metal salt, hydrogen peroxide to obtain a mixture having a pH comprised from 3 to 6, the dosage of metal salt being comprised from 0.003 to 0.009 mol per liter wastewater, the molar ratio of metal salt to hydrogen peroxide being comprised from 1.0:1 to 1.5:1;
(b) reacting a base compound with the mixture obtained at step (a) to form a metal hydroxide precipitation and a liquid medium;
(c) separating off the liquid medium; and
(d) contacting the liquid medium with an ozone containing gas with hydrogen peroxide or ultraviolet radiation with hydrogen peroxide.

The invention also concerns a composition comprising at least:
wastewater comprising at least chemical oxygen demand (COD) comprised from 100 to 500 mg/L,
at least one metal salt,
hydrogen peroxide, and
molar ratio of metal salt to hydrogen peroxide being comprised from 1.0:1 to 1.5:1.

This invention realizes the deep COD treatment by the combination of metal salt and hydrogen peroxide and then by an ozone containing gas and hydrogen peroxide or ultraviolet radiation with hydrogen peroxide. Less metal salt and hydrogen peroxide is used in this invention. The reaction liquid obtained at step (a) is neutralized by a base compound to increase the ozone utilization efficiency. The dosage of metal salt of present invention is much lower than CN101723485 and therefore is more environmentally friendly and easy for industrial operation.

Other characteristics, details and advantages of the invention will emerge more fully upon reading the description which follows.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

Throughout the description, including the claims, the term “comprising one” should be understood as being synonymous with the term “comprising at least one”, unless otherwise specified, and “between” should be understood as being inclusive of the limits.

It should be noted that in specifying any range of concentration, any particular upper concentration can be associated with any particular lower concentration.

It is specified that, in the continuation of the description, unless otherwise indicated, the values at the limits are included in the ranges of values which are given.

As used herein, wastewater refers to any water that has been adversely affected in quality by anthropogenic influence. Wastewater can originate from a combination of domestic, industrial, commercial or agricultural activities, surface runoff or stormwater, and from sewer inflow or infiltration. It can be biological wastewater.

As used herein, Chemical Oxygen Demand (hereinafter COD) is a measurement of the oxygen required to oxidize soluble and particulate organic matter in water.

A common method for COD analysis could refer to Standard Methods for the Examination of Water and Wastewater according to American Public Health Association (APHA).

As used herein, Total Organic Carbon (hereinafter TOC) is the amount of carbon found in an organic compound.

Method for analysing TOC could be determined by a specific analytic instrument, such as SHIMADZU TNM-1, Japan (Software SHIMADZU TOC-control V Version 2.30).

As used herein, metals of group IB, IIB, IIIB, IVB, VB, VIB, VIIB and VIIIB are often referred to as transition metals. This group comprises the elements with atomic number 21 to 30 (Sc to Zn), 39 to 48 (Y to Cd), 72 to 80 (Hf to Hg) and 104 to 112 (Rf to Cn).

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 70° C. to about 85° C. should be interpreted to include not only the explicitly recited limits of about 70° C. to about 85° C., but also to include sub-ranges, such as 75° C. to 80° C., 80° C. to 85° C., and so forth, as well as individual amounts, including fractional amounts, within the specified ranges, such as 72.20° C., 80.60° C., and 83.30° C., for example.

The term “from” should be understood as being inclusive of the limits.

It is specified that, in the continuation of the description, unless otherwise indicated, the values at the limits are included in the ranges of values which are given. It should be noted that in specifying any range of weight ratio or temperature, any particular upper weight ratio or temperature can be associated with any particular lower concentration.

Should the disclosure of any patents, patent applications, and publications which are incorporated herein by reference conflict with the description of the present application to the extent that it may render a term unclear, the present description shall take precedence.

### DETAILS OF THE INVENTION

The present invention provides a process for treating wastewater comprising at least chemical oxygen demand (COD) comprised from 100 to 500 mg/L, comprising at least the following steps:

(a) contacting at least the wastewater with a composition comprising at least one metal salt and hydrogen peroxide to obtain a mixture having a pH comprised from 3 to 6, the dosage of metal salt being comprised from 0.003 to 0.009 mol per liter wastewater, the molar ratio of metal salt to hydrogen peroxide being comprised from 1.0:1 to 1.5:1;
(b) reacting a base compound with the mixture obtained at step (a) to form a metal hydroxide precipitation and a liquid medium;
(c) separating off the liquid medium; and
(d) contacting the liquid medium with an ozone containing gas with hydrogen peroxide or ultraviolet radiation with hydrogen peroxide.

The COD in wastewater is comprised from 100 to 500 mg/L and more preferably from 250 to 350 mg/L.

The TOC in wastewater could be preferably from 30 to 150 mg/L and more preferably from 70 to 100 mg/L.

Step (a) The wastewater before treating preferably has a pH comprised from 7.0 to 9.0 and more preferably from 7.5 to 8.5. Notably pH is equal to 7.5, 7.6, 7.7, 7.8, 7.9, 8.0, 8.1, 8.2, 8.3, 8.4, 8.5 or any range obtained between these values.

In present invention, an acid compound could be optionally employed in step (a) to adjust the pH value. The sequence for adding the metal salt, hydrogen peroxide and acid is not particularly limited. They can be added in to wastewater simultaneously or respectively. In a preferred embodiment, metal salt and hydrogen peroxide are added first and acid is then added slowly to adjust the pH value. It is possible to add in the the mixture of step (a) a salt, for example, acid salt such as NaHCO₃, NaHS, NaHSO₄, NaH₂PO₄ and Na₂HPO₄.

The acid compound employed in step (a) could be organic, inorganic acid. It could be notably inorganic acid, such as mineral acids: hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI). Among these, hydrochloric acid (HCl) or sulfuric acid (H₂SO₄) is more preferable.

The pH of the mixture may be preferably from 4.5 to 5.5. Notably pH is equal to 4.5, 4.6, 4.7, 4.8, 4.9, 5.0, 5.1, 5.2, 5.3, 5.4, 5.5 or any range obtained between these values.

The metal salt of present invention comprises at least one transition metal element or at least one element of group IIA of the Periodic Table. Preferably, the metal salt may comprise at least one metal element chosen in the group consisting of Fe, Co, Ni, Mg, Zn, W and Cu and more preferably chosen in the group consisting of Fe, Mg and Zn and most preferably Fe.

Examples of metal salt notably are:
iron(II) salts, such as iron(II) sulfate(FeSO₄), iron(II) chloride(FeCl₂), iron(II) bromide(FeBr₂), iron(II) fluoride(FeF₂), iron(II) oxalate(FeC₂O₄) and iron(II) perchlorate(Fe(ClO₄)₂).
magnesium salts, such as magnesium sulfate(MgSO₄), magnesium chloride(MgCl₂).
zinc salts, such as zinc sulfate(ZnSO₄), zinc chloride(ZnCl₂).

The dosage of metal salt in step (a) is comprised from 0.003 to 0.009 mol per liter wastewater and could be preferably from 0.003 to 0.006 mol per liter wastewater.

The molar ratio of metal salt to hydrogen peroxide in step (a) could be equal to 1.0:1, 1.1:1, 1.2:1, 1.3:1, 1.4:1, 1.5:1 or any range obtained between these values.

The removal rate of COD by step (a) could be comprised from 20% to 60% and preferably from 40% to 50%.

The removal rate of TOC by step (a) could be comprised from 20% to 60% and preferably from 40% to 50%.

The reaction temperature of step (a) may be comprised from 10 to 100° C. and preferably from 10 to 40° C. It is preferable that the reaction of step (a) occurs at room temperature.

The reaction time of step (a) may be comprised from 0.5 to 3 hours and preferably from 0.5 to 1 hour.

Step (b) The base compound employed in the process could be an organic, inorganic base. It could notably be an inorganic base, such as sodium hydroxide, potassium hydroxide. It is also possible to use a salt, such as sodium carbonate, sodium bicarbonate, potassium carbonate and potassium bicarbonate.

The concentration of base compound used to precipitate the metal hydroxide is not particularly limited. People having ordinary skill in the art could adjust the mixture to precipitate the metal hydroxide by using bases of different concentration.

Optionally, a flocculating agent could be used in this step to increase the flocculating efficiency. As used herein, “flocculating agent” refers to chemical additives that cause suspended solids to form aggregates called flocs. It should be understood any agent which could increase the flocculating efficiency in this invention could be used. Flocculating agent is particularly polyacrylamides (PAM)-soluble polyelectrolytes bearing negative (anionic) or positive (cationic) charge along the chain.

In a preferred embodiment, pH value at the end of step (b) could be comprised from 7 to 13. Preferably, pH value at the end of step (b) may be comprised from 7.5 to 8.5.

Step (c) The method for separating off the liquid medium is not particularly limited and can use several known separation techniques to separate precipitation from mixture obtained at step (b), such as for instance filtrating or centrifuging. Filtration may be made at positive pressure, such as comprised from 0.3 to 0.6 MPa, or under vacuum, such as comprised from 100 to 900 mbar.

Step (d) The said ozone (O₃) containing gas may comprise at least 2 wt % ozone with respect to total weight of gas supplied to the liquid medium. Preferably, the gas may comprise 2 wt % to 20 wt % of ozone with respect to total weight of gas supplied to the liquid medium and more preferably 3 wt % to 8 wt %. The ozone containing gas may also comprise some inert gases such as He, Ne or Ar.

Dosage of ozone gas in this step depends on wastewater source. In a specific embodiment, 1.0-5.0 kg O₃ might be required in order to remove 1 kg COD.

O₃:H₂O₂ mol ratio in step (d) may be comprised from 0.5:1 to 3:1, preferred from 1:1 to 2:1.

O₃ reactor can be designed as plug flow or completed stirred reactor (CSTR), O₃ can be added by diffuser disc or Jet aeration or Venturi injection. H₂O₂ can be added before O₃ injection point with static mixer.

Ultraviolet radiation could be realized by some well-known ultraviolet light equipment, such as ultraviolet light lamp. The UV dosage depends on the wastewater source. In a specific embodiment, it could be comprised from 20 to 500 KWH per stere liquid medium.

When ultraviolet radiation is used in step (d), H₂O₂ dosage depends on the COD in liquid medium. Specifically, H₂O₂:COD mol ratio could be comprised from 1:1 to 3:1 and preferably from 1.5:1 to 2.5:1.

The reaction time of step (d) may be comprised from 0.5 to 10 hours and preferably from 1 to 5 hours.

The COD value obtained at the end of step (d) may be comprised from 20 to 50 mg/L and preferably from 25 to 45 mg/L.

The TOC value obtained at the end of step (d) may be comprised from 5 to 30 mg/L and preferably from 10 to 15 mg/L.

The following examples are included to illustrate embodiments of the invention. Needless to say, the invention is not limited to the described examples.

### EXPERIMENTAL PART

### Example 1

To treat Reverse Osmosis (RO) concentrated effluent (reject effluent), COD=300 mg/L, TOC=100 mg/L.

Step (a): FeSO₄.7H₂O and H₂O₂ was added into wastewater simultaneously. pH of the mixture was adjusted to 5.0 by adding H₂SO₄. The reaction mixture is then stirred for 45 min at room temperature.

FeSO₄.7H₂O dosage:1.0 g/L (0.0036 mol/L)

H₂O₂ dosage: 0.1 g/L (0.0029 mol/L)

FeSO₄.7H₂O:H₂O₂ mol ratio: 1.24:1

Step (b): pH of the liquid medium was adjusted to 8.0 by adding NaOH and then flocculating agent was added (PAM, type: Kemira Superfloc C492PWG) 2 mg/L for flocculation (10 minutes).

Step (c): Then sludge was separated by filtration. The supernant COD decreased from 300 mg/L to 150 mg/L. TOC decreased from 100 mg/L to 50 mg/L.

Step (d): Retention time of O₃/H₂O₂ treatment for liquid medium obtained at step (c) is 30 min. COD further decreased from 150 to 35 mg/L, TOC decreased from 50 to 15 mg/L. The initial pH was 8.0 and end pH was 7.5 without pH control.

O₃ dosage: 0.35 g/L

O₃:COD weight ratio: 3.5:1

O₃:H₂O₂ mol ratio: 2:1

### Example 2

The objective is to treat current outlet from biological wastewater treatment unit (WWTU) for water reuse. To treat COD from 350 mg/L to <50 mg/L.

Step (a): FeSO₄.7H₂O and H₂O₂ was added into wastewater simultaneously. The initial pH is 7.2. After FeSO₄.7H₂O and H₂O₂ is input, pH automatically decreased to 4.0. The reaction mixture is then stirred for 45 min at room temperature.

FeSO₄.7H₂O dosage: 1.5 g/L (0.0054 mol/L)

H₂O₂ dosage: 0.16 g/L (0.0047 mol/L)

FeSO₄.7H₂O:H₂O₂ mol ratio: 1.15:1

Step (b): pH of the liquid medium was adjusted to 8.5 by adding NaOH and then flocculating agent was added (PAM, type: Kemira Superfloc C492PWG) 2 mg/L for flocculation (10 minutes).

Step (c): Then sludge was separated by filtration. COD decreased from 350 mg/L to 180 mg/L. TOC decreased from 120 mg/L to 60 mg/L.

Step (d): UV/H₂O₂ treatment. The Lab reactor (volume 5.0 L) included two parts: 1) photo reactor with UV lamp inside; 2) main reactor. A recycle pump is used to build a loop between main reactor and photo reactor. After 2 hours reaction, COD decreased from 180 to 30 mg/L.

Reaction condition: UV power 100 W, reaction time 2 hours, UV dosage=100 W*2 h/5.0 L=20 KWh/m³, H₂O₂:COD mol ratio=2.0:1, H₂O₂ dosage:380 mg/L.

### Example 3

The experiments were performed by the same way of step (a) in EXAMPLE 1. Results with different reaction parameters are expressed in Table 1.

Different FeSO₄.7H₂O:H₂O₂ mol ratios (1.0, 1.2, 1.5) were tried with same FeSO₄.7H₂O dosage (0.0036 mol/L) and initial pH (5.0). It is shown that FeSO₄.7H₂O:H₂O₂ mol ratio of 1.2 has better performance.

Different FeSO₄.7H₂O dosages were tried with same FeSO₄.7H₂O:H₂O₂ mol ratio (1.2) and initial pH (5.0). It is shown that FeSO₄.7H₂O dosage of 0.0054 mol/L has better performance.

Different pH was tried with same FeSO₄.7H₂O dosage (0.0054 mol/L) and FeSO₄.7H₂O:H₂O₂ mol ratios. It is shown that pH of 4.5 has better performance.

TABLE 1

| | FeSO₄•7H₂O | FeSO₄•7H₂O:H₂O₂ | | Inlet | Outlet | COD |
|---|---|---|---|---|---|---|
| Trial | dosage | ratio | Intial | COD | COD | removal |
| unit | mol/L | mol:mol | pH | mg/L | mg/L | % |
| 1 | 0.0036 | 1.0 | 5 | 300 | 168 | 44.3 |
| 2 | 0.0036 | 1.2 | 5 | 300 | 160 | 46.7 |
| 3 | 0.0036 | 1.5 | 5 | 300 | 186 | 38.0 |
| 4 | 0.0045 | 1.2 | 5 | 300 | 150 | 50.0 |
| 5 | 0.0054 | 1.2 | 5 | 300 | 145 | 51.7 |
| 6 | 0.0054 | 1.2 | 4.5 | 300 | 142 | 52.7 |
| 7 | 0.0054 | 1.2 | 5.5 | 300 | 151 | 49.7 |
| 8 | 0.0054 | 1.2 | 6 | 300 | 178 | 40.7 |

### Example 4

The experiments were performed by the same way of step (d) in EXAMPLE 1. Results with different parameters are expressed in Table 2.

Different pH was tried with same O₃ dosage 0.35 g/L and same H₂O₂ dosage (O₃:H₂O₂ mol ratio=2.0). It is shown COD removal efficiency increases when pH is increased.

Different O₃:H₂O₂ mol ratios were tried with same pH value and O₃ dosage. It is shown O₃:H₂O₂ mol ratio of 2.0 has better performance.

TABLE 2

| | | | | | | | kg O₃/kg |
|---|---|---|---|---|---|---|---|
| | | O₃ | O₃:H₂O₂ | Inlet | Outlet | COD | removed |
| | Intial | dosage | mol ratio | COD | COD | removal | COD |
| Trial | pH | g/L | mol:mol | mg/L | mg/L | % | kg/kg |
| 1 | 6 | 0.35 | 2 | 160 | 70 | 56.3 | 3.9 |
| 2 | 7 | 0.35 | 2 | 160 | 50 | 68.8 | 3.2 |
| 3 | 7.5 | 0.35 | 2 | 160 | 45 | 71.9 | 3.0 |
| 4 | 8.5 | 0.35 | 2 | 160 | 35 | 78.1 | 2.8 |
| 5 | 9 | 0.35 | 2 | 160 | 32 | 80.0 | 2.7 |
| 6 | 8.5 | 0.35 | 1 | 160 | 38 | 76.2 | 2.9 |
| 7 | 8.5 | 0.35 | 3 | 160 | 45 | 71.8 | 3.0 |
| 8 | 8.5 | 0.35 | 3.5 | 160 | 57 | 64.3 | 3.4 |
| 9 | 8.5 | 0.35 | 4 | 160 | 69 | 56.8 | 3.8 |

1. A process for treating wastewater having a chemical oxygen demand of from 100 to 500 mg/L, comprising:
(a) contacting the wastewater with a composition comprising at least one metal salt and hydrogen peroxide, at a dosage of metal salt of from 0.003 to 0.009 mole of metal salt per liter wastewater and a molar ratio of metal salt to hydrogen peroxide of from 1.0:1 to 1.5:1, to obtain a mixture having a pH of from 3 to 6;
(b) contacting a base compound with the mixture obtained at step (a) to form a metal hydroxide precipitate and a liquid medium;
(c) separating the liquid medium and precipitate; and
(d) contacting the liquid medium with an ozone containing gas and hydrogen peroxide or with ultraviolet radiation and hydrogen peroxide.

2. The process according to claim 1, wherein step (a) further comprises contacting the wastewater with an acid compound to adjust the pH of the mixture obtained in step (a).

3. The process according to claim 1, wherein the metal salt comprises at least one metal element selected from the group consisting of Fe, Co, Ni, Mg, Zn, W, and Cu.

4. The process according to claim 1, wherein the step (a) reduces the chemical oxygen demand of the wastewater by from 20% to 60%.

5. The process according to claim 1, wherein the wastewater exhibits a total organic carbon content and step (a) reduces the total organic carbon content of the wastewater by from 20% to 60%.

6. The process according to claim 1, wherein pH value at the end of step (b) is from 7.5 to 8.5.

7. The process according to claim 1, wherein step (d) comprises contacting the liquid medium with an ozone containing gas and hydrogen peroxide at molar ratio of ozone to hydrogen peroxide of from 0.5:1 to 3:1.

8. The process according to claim 1, wherein step (d) comprises contacting the liquid medium with ultraviolet radiation and hydrogen peroxide at a molar ratio of hydrogen peroxide to chemical oxygen demand of from 1:1 to 3:1.

9. The process according to claim 1, wherein at the end of step (d) the liquid medium exhibits a chemical oxygen demand of from 20 to 50 mg/L.

10. The process according to claim 1, wherein at the end of step (d) the liquid medium exhibits a total organic carbon value of from 5 to 30 mg/L.

11. A composition, comprising:
wastewater having a chemical oxygen demand of from 100 to 500 mg/L,
at least one metal salt, and
hydrogen peroxide,
wherein the metal salt and hydrogen peroxide are present in a molar ratio of metal salt to hydrogen peroxide of from 1.0:1 to 1.5:1.

12. The process according to claim 3, wherein the metal salt comprises at least one metal element selected from the group consisting of Fe, Mg, and Zn.

13. The process of claim 12, wherein the metal salt comprises Fe.
